(19) United States
(12) Patent Application Publication
(10) Pub. No.: US 2006/0157294 A1
(43) Pub. Date: Jul. 20, 2006

(54) Rack and pinion type steering gear

(75) Inventors: Seiji Ueno, Gunma (JP); Kazuo Chikaraishi, Gunma (JP)

Correspondence Address: SUGHRUE MION, PLLC, 2100 PENNSYLVANIA AVENUE, N.W., SUITE 800, WASHINGTON, DC, 20037, US

(73) Assignee: NSK LTD.

(21) Appl. No.: 11/318,537

(22) Filed: Dec. 28, 2005

(30) Foreign Application Priority Data
Dec. 28, 2004 (JP) P2004-381293

(51) Int. Cl. B62D 5/04

(52) U.S. Cl. 180/444

(57) ABSTRACT

Due to the meshing of the gears, the following force works on the rack. A separating force (Fα) determined by a pressure angle of gears, a lateral force (Fβ) determined by an angle of torsion of the rack, and drag (Fr) for offsetting angular moment occurring in the rack due to the lateral force (Fβ). A resultant (F) of the force works from the rack on the rack guide. When the line of this resultant (F) is held on the “inner side” of the end portions of the needle bearing 25 in this rolling type rack guide 21, the rotation of the roller 22 becomes stable.

The present application claims foreign priority under 35 USC 119 based on Japanese Patent Application No. 2004-381293, filed on Dec. 28, 2004, the contents of which is incorporated herein by reference in its entirety, and concurrently with the filing of this U.S. patent application.

### BACKGROUND OF THE INVENTION

This invention relates to a rack and pinion type steering gear.

In a rack and pinion type steering gear for vehicles, a rack is meshed with a pinion mounted on an output shaft of a steering shaft as disclosed in, for example, the Patent Document 1. A rack guide constantly presses a roller against a rear surface of the rack by an adjust cover. The roller is supported rotatably on a pivot via a needle bearing. The adjust cover presses the roller against the rear surface of the rack via a spring. Owing to this structure, a backlash of meshed portions of the pinion and rack is eliminated to enable the rack to be smoothly moved.

The supporting of the rear surface of the rack by the guide usually eliminates a backlash of the gear, and renders normal the meshing of the pinion and rack with each other. The rack guide in use is generally a slide type rack guide, and there is also a rolling type rack guide using a roller which is designed so as to obtain a high efficiency.

[Patent Document 1] JP-A-2002-79946

In a related art manual steering gear, the torque inputted into a pinion is only a driver's manual input, which is around 10 Nm at most.

On the other hand, in an electric power steering system (EPS), an output tends to become high, and, when a steering gear is used in combination with EPS, torque of not lower than 90 Nm is to be inputted.

In view of the layout of the parts mounted on the vehicle, the size of the rack guide is limited. For this reason, it is impossible that the size of the rack guide be increased at the same rate at which the output from the EPS increases.

Owing to the meshing of the gears, the following force works on the rack.

Separating force (Fα) determined by a pressure angle of the gears.

Lateral force (Fβ) determined by an angle of torsion of the rack.

Drag (Fr) for offsetting angular moment (Mβ) occurring in the rack due to the lateral force (Fβ).

The resultant force works from the rack on the rack guide.

When the line of action of this resultant force in a rolling type rack guide is directed to the “outer side” with respect to an end portion of the needle bearing to cause high torque to be inputted by EPS, twisting occurs in the roller. As a result, the rotation of the roller becomes unstable to cause the efficiency to lower in some cases.

In the needle bearing, a large edge load occurs, and the lifetime thereof decreases.

### SUMMARY OF THE INVENTION

The present invention is made in view of these circumstances, and aims at providing a rack and pinion type steering gear capable of increasing the efficiency and lifetime of a rolling rack guide when the steering gear is used in combination with ESP.

To achieve this object, according to Aspect 1 of the present invention, there is provided with a rack and pinion type steering gear combined with an electric-power steering system, including:

a rack shaft,

a pinion shaft engaging with the rack shaft, and

a rolling rack guide, wherein

a line of action of a load imparted to a rack which is determined by a force for separating the rack by an input torque of a pinion and a lateral force working on the rack in parallel with the pinion shaft is held on the inner side of a roller-supporting needle bearing.

According to the present invention, the line of action of a load due to the meshing of the gears is held on the “inner side” of the roller-supporting needle bearing. Therefore, the twisting of the roller due to a fall thereof is eliminated, and the efficiency is improved. Moreover, the edge load of the needle bearing decreases, and the lifetime thereof is prolonged.

### BRIEF DESCRIPTION OF THE DRAWINGS

FIG. 1 is a front view including a partially cutaway section of the rack and pinion type steering gear in the mode of embodiment of the present invention.

FIG. 2 is a drawing showing a cross section taken along the line A-A in FIG. 1.

FIG. 3 is a drawing showing drag (Fr) with respect to separating force (Fα), -lateral force (Fβ) and rack rolling.

FIG. 4 is a drawing showing the relation between the resultant (F) of drag (Fr) and separating force (Fα), lateral force (Fβ) and rack rolling.

FIG. 5 is a drawing showing the relation between the angle (β) of torsion of the rack and angle (θ) of line of action.

### DETAILED DESCRIPTION OF THE PREFERRED EMBODIMENTS

The rack and pinion type steering gear in the mode of embodiment of the present invention will now be described with reference to the drawings.

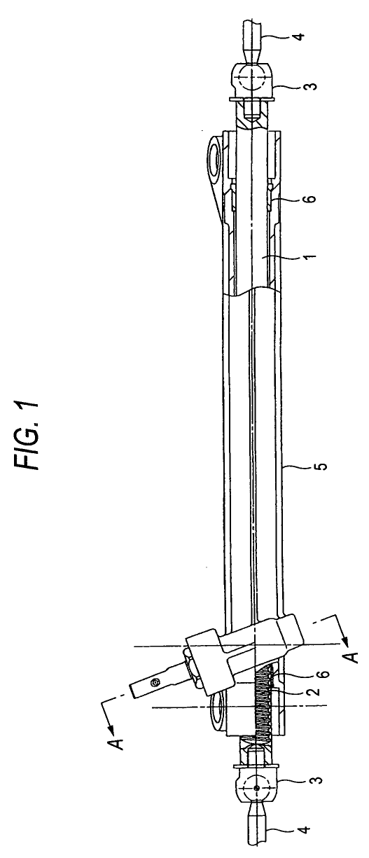

FIG. 1 is a front view including a partially cutaway section of the rack and pinion type steering gear in the mode of embodiment of the present invention.

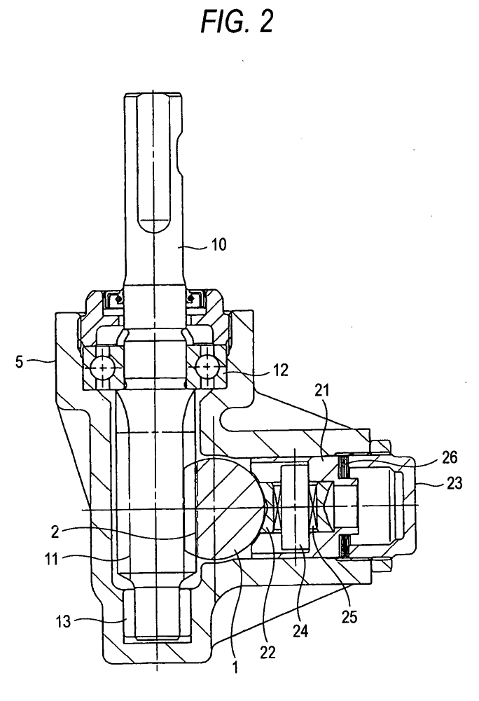

FIG. 2 is a drawing showing a section taken along the line A-A shown in FIG. 1.

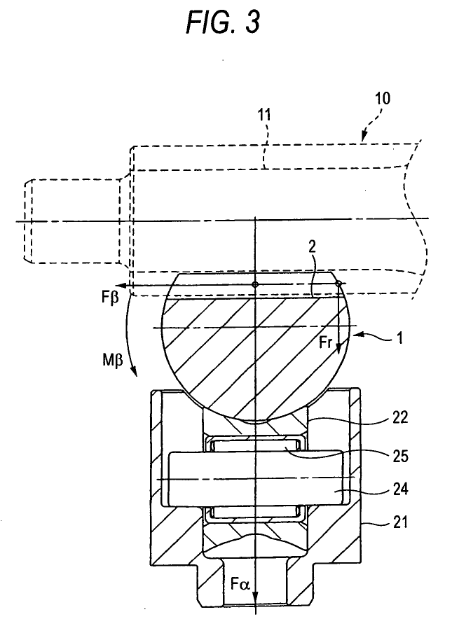

FIG. 3 is a drawing showing drag (Fr) with respect to a separating force (Fα), a lateral force (Fβ) and rack rolling.

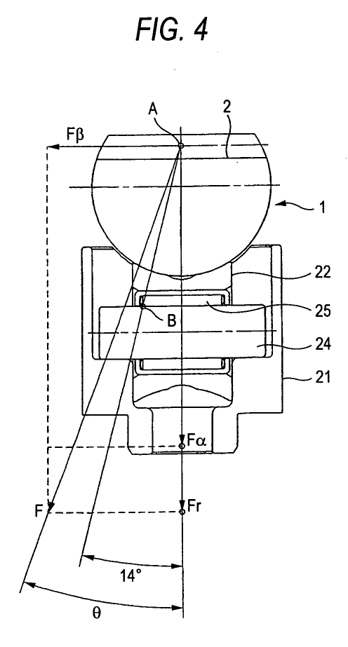

FIG. 4 is a drawing showing the relation of a resultant (F) of the drag (Fr) with respect to the separating force (Fα), lateral force (Fβ) and rack rolling.

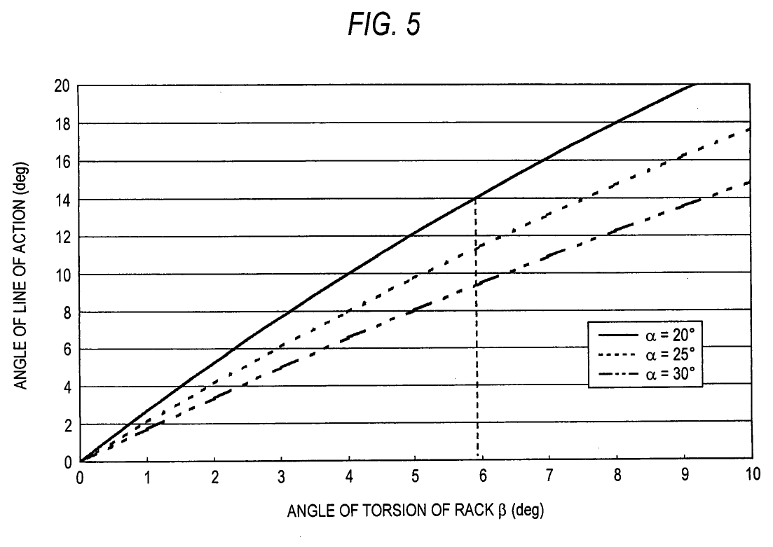

FIG. 5 is a drawing showing the relation between an angle (β) of torsion of the rack and an angle (θ) of the line of action.

In this mode of embodiment, the rack shaft 1 has as shown in FIG. 1 a rack 2 meshed with a pinion 11 which will be described later, and spherical joints 3 supporting tie rods 4 pivotably are fixed to left and right ends of the rack shaft 1. The rack shaft 1 is slidably supported on rack bushes 6 provided on both ends of a housing 5.

In the gear box 5 (housing), a pinion shaft 10 having a pinion 11 meshed with the rack 2 mounted on the rack shaft 1 is supported rotatably as shown in FIG. 2.

A rolling type rack guide 21 constantly presses the roller 22 against a rear surface of the rack 2 by an adjust cover 23.

The roller 22 is supported rotatably on a pivot 24 via a needle bearing 25. The needle bearing 25 is press fitted firmly in an inner surface of the roller 22, and the pivot 24 is supported at both end portions thereof on the rack guide 21. The adjust cover 23 is fixed to the gear box 5 (housing) so that the adjust cover 23 can press the rack guide 21 elastically via a disc spring 26 so as to enable the roller 2 to be pressed against the rear surface of the rack 2.

Owing to this structure, a backlash of the meshed portions of the pinion 11 and rack 2 is eliminated to enable the rack to be smoothly moved. When the pinion 11 is rotated to cause the rack 2 to be slidingly moved, the sliding resistance of the rack decreases owing to the rotation of the roller 2 which presses the rack 2.

As shown in FIG. 3 or 4, the following force works on the rack due to the meshing of the gears.

Separating force (Fα) determined by a pressure angle of the gears.

Lateral force (Fβ) determined by an angle of torsion of the rack.

Drag (Rr) for offsetting angular moment (Mβ) occurring in the rack due to the lateral force (Fβ).

A resultant (F) of the above force works from the rack on the rack guide.

When the line of action of this resultant (F) in the rolling type rack guide 21 is held on the “inner side” of the end portions of the needle bearing 25, the rotation of the roller becomes stable.

According to the mode of this embodiment, it is clear that the line of action of a load due to the meshing of the gears is held on the “inner side” of the needle bearing 25 supporting the roller 22. Therefore, the twisting of the roller due to a fall thereof is eliminated, and the efficiency is improved. Moreover, the edge load on the needle bearing 25 decreases, so that the lifetime thereof is prolonged.

When the line of action of the load mentioned above is directed to the “outer side” of the end portion of the needle bearing 25 just as that of a similar load in the related art steering gear, distortion occurs in the roller 22. As a result, the rotation of the roller 22 becomes unstable, and the efficiency lowers.

In the actual designing of the steering gear, the size of the rack guide 21 is limited due to the insufficient space. Therefore, it is preferable to design the steering gear so that the line of action of the load mentioned above be held on the “inner side” of the needle bearing 25 by regulating the items of gears (pressure angle α and angle β of torsion) on the basis of the size of the rack guide 21.

In the position in which the rack guide 21 is provided in the mode (FIG. 4) of embodiment, an angle θ formed by a perpendicular line of the rack guide 21 and a line connecting the meshed portion A of the gears and the end portion B of the needle bearing 25 is 14°.

The relation between the angle (β) of torsion of the rack and the angle (θ) of the line of action is shown in FIG. 5. It is understood from FIG. 5 that, when, for example, the pressure angle is set to 20°, the angle of torsion of the rack is preferably set to not larger than 5.9°.

The present invention is not limited to this mode of embodiment but can be modified in various manners.

What is claimed is:

1. A rack and pinion type steering gear combined with an electric power steering system, comprising:
a rack shaft,
a pinion shaft engaging with the rack shaft, and
a rolling rack guide, wherein
a line of action of a load imparted to a rack which is determined by a force for separating the rack by an input torque of a pinion and a lateral force working on the rack in parallel with the pinion shaft is held on the inner side of a roller-supporting needle bearing.

2. The rack and pinion type steering gear according to claim 1, wherein
an angle formed by a perpendicular line of the rack guide and the needle bearing is 14°.

3. The rack and pinion type steering gear according to claim 1, wherein
when the pressure angle is set to 20°, the angle of torsion of the rack is set to not larger than 5.9°.
